(19) United States
(12) Patent Application Publication
(10) Pub. No.: US 2020/0141572 A1
(43) Pub. Date: May 7, 2020

(54) COMBUSTION DEVICE AND INFRARED REFLECTIVE PLATE

(71) Applicant: GRAND MATE CO., LTD., TAICHUNG CITY (TW)

(72) Inventors: CHUNG-CHIN HUANG, TAICHUNG CITY (TW); CHIN-YING HUANG, TAICHUNG CITY (TW); HSIN-MING HUANG, TAICHUNG CITY (TW); HSING-HSIUNG HUANG, TAICHUNG CITY (TW); YEN-JEN YEH, TAICHUNG CITY (TW); KUAN-CHOU LIN, TAICHUNG CITY (TW)

(73) Assignee: GRAND MATE CO., LTD., TAICHUNG CITY (TW)

(21) Appl. No.: 16/180,901

(22) Filed: Nov. 5, 2018

(51) Int. Cl. F23D 14/14; G02B 5/10; G02B 5/09

(52) U.S. Cl. CPC F23D 14/14; G02B 5/09; G02B 5/10

(57) ABSTRACT

A combustion device includes at least one burner, an infrared reflective plate, and an infrared ray generation mesh. The at least one burner includes a flame outlet; the supporting assembly includes a cover plate which has an opening corresponding to the flame outlet and a plurality of holes; the infrared ray generation mesh is disposed on the supporting assembly and is heated by the flames out of the flame outlet to generate infrared rays; and the infrared reflective plate has a reflective surface for reflecting the incident infrared rays out of the infrared ray generation mesh is disposed between the rear cover and the infrared ray generation mesh. The combustion device is favorable to generate stronger and more uniform infrared rays.

### BACKGROUND OF THE INVENTION

### 1. Technical Field

The present invention is related to a heating device, and more particularly to an infrared reflective plate of a combustion device which utilizes infrared rays to heat an object.

### 2. Description of Related Art

Among conventional heating apparatus, a device that provides heat usually utilizes thermal energy generated by open fire to be applied to an object. However, heat is conducted from the surface of the object to the inside thereof, resulting in the object not being heated uniformly. Taking food heating as an example, the outer surface of food will be first heated by thermal energy which is generated by the open fire, and the thermal energy is then conducted gradually to the interior of the food. It often brings about overheating on food surface but being undercooked in the interior.

A common way to resolve the above problem is to utilize infrared rays which are characterized by penetrating objects to heat food, such that the heat inside and outside of the food tends to be uniform. Currently, a normal way to generate infrared rays is to use an infrared ray burner which applies flames to an infrared ray generation device, such as a ceramic plate, so the ceramic plate is heated to generate infrared rays. However, the efficiency of the heated ceramic plate converting into infrared rays is limited, and the open fire is too small to heat the surface of the food to golden brown.

Hence, it is still a need to provide an improvement on the design of the conventional heating device so as to overcome the aforementioned drawbacks.

### BRIEF SUMMARY OF THE INVENTION

In view of the above, a purpose of the present invention is to provide an infrared reflective plate which could increase the efficiency of generating infrared rays by infrared ray generation device.

Another purpose of the present invention is to provide a combustion device which could generate infrared rays and open fire efficiently.

The present invention provides an infrared reflective plate which has a reflective surface to reflect infrared rays. The reflective surface includes a reflective structure comprising a plurality of convex parts and a plurality of embossings, each of the embossings located between two adjacent convex parts.

The present invention provides a combustion device including at least one burner, an infrared ray generation mesh and an infrared reflective plate. Wherein, the at least one burner has a flame outlet and burns gas to generate flames through the flame outlet; the infrared ray generation mesh which is corresponding to the flame outlet has a front side surface and a rear side surface positioned back-to-back; the infrared ray generation mesh is flame heated by the at least one burner to generate infrared rays; and the infrared reflective plate disposed outside the rear side surface of the infrared ray generation mesh includes a reflective surface facing the rear side surface, the reflective surface having a reflective structure which comprises a plurality of convex parts and a plurality of embossings, each of the embossings located between two adjacent convex parts.

The advantage of the present invention is to achieve more uniformly heating on an infrared ray generation mesh with a reflective structure of an infrared reflective plate, and to keep the high temperature of the infrared ray generation mesh such that the combustion device is favorable to generate stronger and more uniform infrared rays.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a combustion device of a first embodiment according to the present invention;

FIG. 2 is a cross-sectional view of the combustion device of the first embodiment;

FIG. 3 is an exploded view of the combustion device of the first embodiment;

FIG. 4 is a top view showing a matrix arrangement of a reflective structure of an infrared reflective plate;

FIG. 5 is a cross-sectional view of FIG. 4 along lines A-A′;

FIG. 6 is a top view showing a staggered arrangement of a reflective structure of an infrared reflective plate;

FIG. 7 is a schematic view showing infrared rays emitted from the combustion device;

FIG. 8 is a perspective view of a combustion device of a second embodiment;

FIG. 9 is an exploded view of the combustion device of the second embodiment;

FIG. 10 is a perspective view of an infrared reflective plate of a third embodiment;

FIG. 11 is a partial perspective view of an infrared reflective plate of a fourth embodiment;

### DETAILED DESCRIPTION OF THE INVENTION

The following illustrative embodiments and drawings are provided to illustrate the disclosure of the present invention, these and other advantages and effects can be clearly understood by persons skilled in the art after reading the disclosure of this specification.

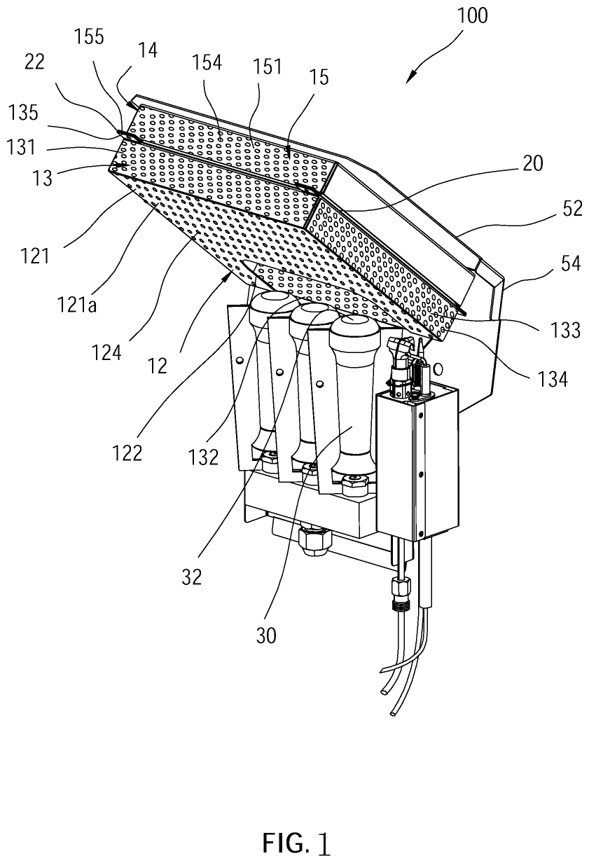

As illustrated in FIG. 1 to FIG. 7, a combustion device 100 of the first embodiment according to the present invention includes a supporting assembly 10, an infrared ray generation device exemplified by an infrared ray generation mesh 20, an infrared reflective plate 40 and at least one burner 30.

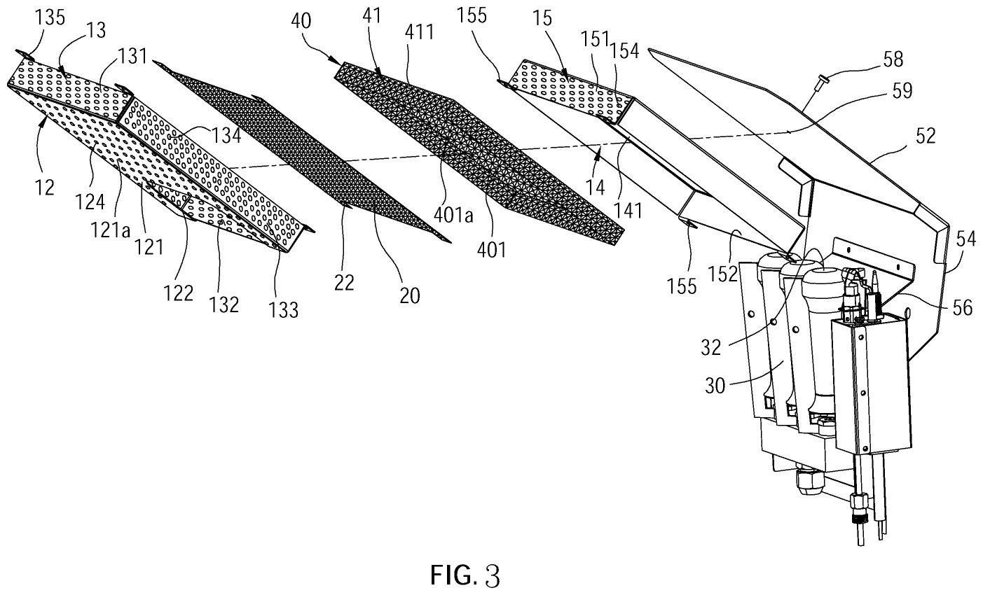

As illustrated in FIG. 3, the supporting assembly 10 comprises a tilted metallic front cover 12 and a rear cover 14. Wherein, the front cover 12 has a flat rectangular cover plate 121 including a plurality of holes 124 passing between an exterior surface and an interior surface thereof. The tilted front cover 12 further comprises a surrounding wall 13 which has an upper side wall 131 connected to a top edge of the cover plate 121, a lower side wall 132 connected to a bottom edge of the cover plate 121, and two side walls 133 connected to corresponding two side edges of the cover plate 121. All the upper side wall 131, the lower side wall 132 and two side walls 133 have a plurality of holes 124 passing between an interior surface and an exterior surface of the surrounding wall 13. The surrounding wall 13 of the front cover 12 extends outwardly to form a plurality of first extension parts 135, each of which is located respectively on the upper side wall 131 and the lower side wall 132 in the current embodiment. The cover plate 121 has an opening 122 which is located in the vicinity of the bottom edge of the cover plate 121 and passes through the interior surface and the exterior surface thereof.

The rear cover 14 which is tilted and metallic has a flat rectangular rear plate 141 and further includes a surrounding wall 15 connected to a peripheral edge of the rear plate 14. The surrounding wall 15 has an upper side wall 151 and a lower side wall 152, wherein the upper side wall 151 is connected to a top edge of the rear plate 141 and has a plurality holes 154 passing between an interior surface and an exterior surface of the surrounding wall 15 of the rear cover 14. The surrounding wall 15 of the rear cover 14 extends outwardly to form a plurality of second extension parts 155, each of which is located respectively on the upper side wall 151 and the lower side wall 152 in the current embodiment.

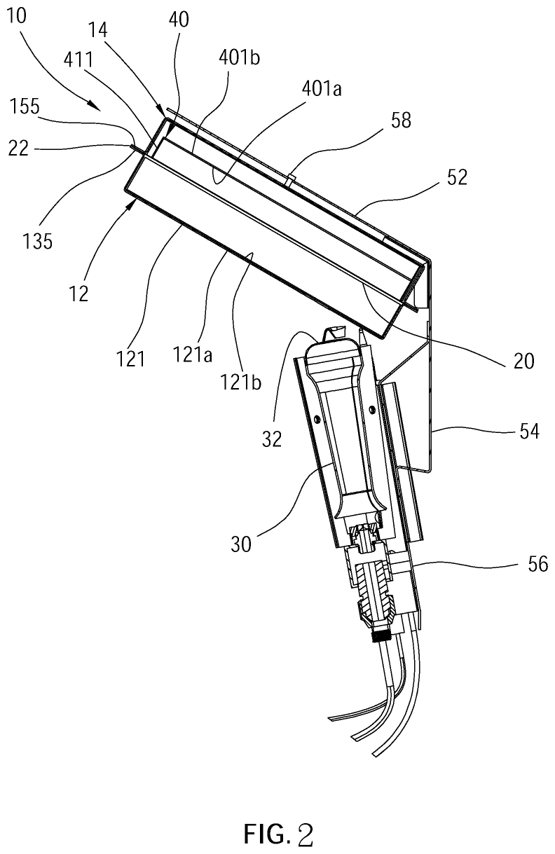

As illustrated in FIG. 2, the infrared ray generation mesh 20 which is disposed between the front cover 12 and the rear cover 14 of the supporting assembly 10 faces the interior surface 121a of the cover plate 121. A peripheral edge of the infrared ray generation mesh 20 extends outwardly to form a plurality of fixation parts 22 (as shown in FIG. 3), each of which corresponds to each of the first extension parts 135 and each of the second extension parts 155. And, each of the fixation parts 22 is disposed between each of the first extension parts 135 and corresponding one of the second extension parts 155 by bolt-nut combining or welding, such that the front cover 12 and the infrared ray generation mesh 20 are fixed to the rear cover 14. The infrared ray generation mesh 20 is flame heated to generate infrared rays emitted outwardly out of the holes 124 of the front cover 12. The infrared ray generation mesh 20 could be a ceramic, metal or alloy material and, in the current embodiment, is iron-chromium-aluminum alloy.

As illustrated in FIG. 1, the at least one burner 30 includes a flame outlet 32 disposed below the opening 122 of the cover plate 121 and the infrared ray generation mesh 20 corresponds to the flame outlet 32. The at least one burner 30 burns gas for generating flames out of the flame outlet 32 to apply the flames to the infrared ray generation mesh 20. In the current embodiment, the at least one burner 30 includes a plurality of burners 30, each flame outlet 32 of which generates flames passing through the opening 122 of the cover plate 121 so as to heat the infrared ray generation mesh 20. In practice, it works as long as flames are applied to the infrared ray generation mesh 20. Therefore, the burner 30 can extend into the opening 122 such that the location of the flame outlet 32 is located in a chamber formed by the front cover 12 and the rear cover 14 and is adjacent to the infrared ray generation mesh 20.

As illustrated in FIG. 2, the infrared reflective plate 40 is located between the rear cover 14 and the infrared ray generation mesh 20. Wherein, the infrared reflective plate 40 which is tilted has a flat rectangular main board 401 (as shown in FIG. 3) and further comprises a surrounding wall 41 connected to a peripheral edge of the main board 401. The surrounding wall 41 of the infrared reflective plate 40 has an upper side wall 411 connected to a top edge of the main board 401. The height of the surrounding wall 41 of the infrared reflective plate 40 is lower than that of the surrounding wall 15 of the rear cover 14. The infrared reflective plate 40 has a reflective surface 401a and an exterior surface 401b, wherein the reflective surface 401a facing the infrared ray generation mesh 20 is adapted to reflect back infrared rays generated by the infrared ray generation mesh 20, such that the reflected infrared rays apply to the infrared ray generation mesh 20 and are emitted outwardly from the holes 124 of the front cover 12. The infrared reflective plate 40 is metallic, such as stainless steel.

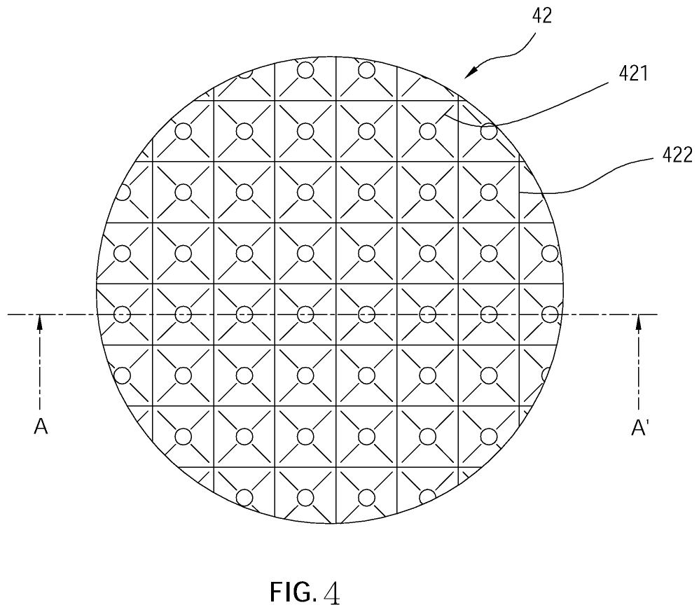

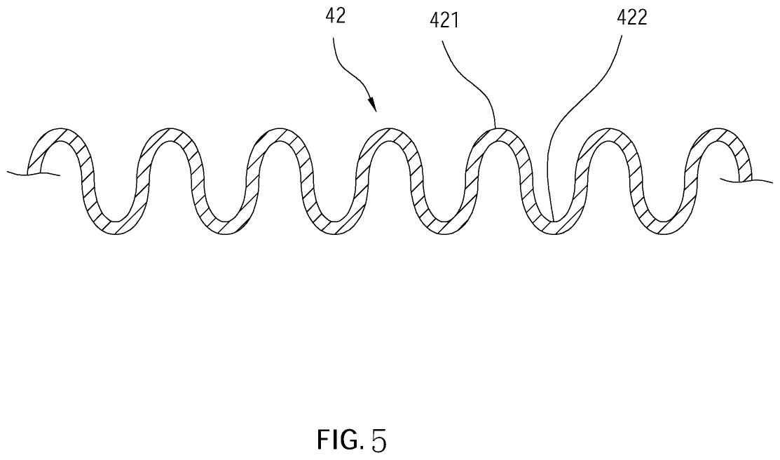

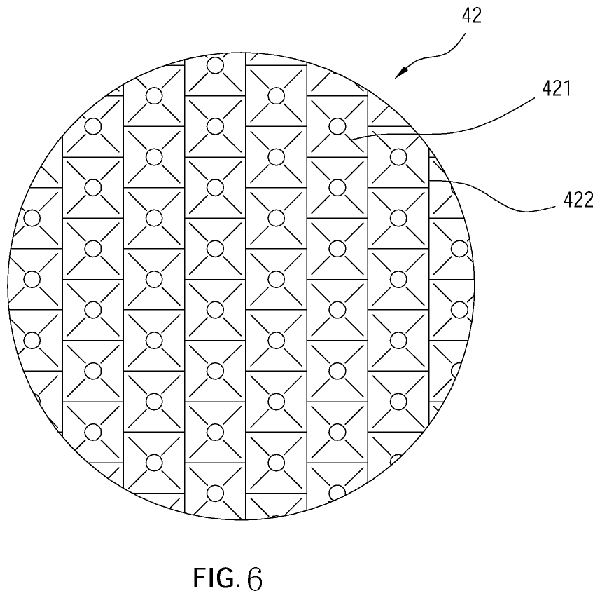

The reflective surface 401a of the infrared reflective plate 40 includes a reflective structure 42 which comprises a plurality of convex parts 421 and a plurality of embossings 422, each of the embossings 422 located between two adjacent convex parts 421. The convex parts 421 and the embossings 422 are roll-embossed out of a metallic plate and then the metallic plate with the reflective structure 42 is folded to form the shape of the main board 401 and the surrounding wall 41 such that the infrared reflective plate 40 is full of the reflective structure 42. In the current embodiment, the convex parts 421 are conical and form a matrix arrangement (as shown in FIGS. 4 and 5) or a staggered arrangement (as shown in FIG. 6). Wherein, the reflective structure 42 is for reflecting incident infrared rays of the reflective surface 401a to scatter the incident infrared rays of the reflective surface 401a back on the infrared ray generation mesh 20 again. The infrared ray generation mesh 20 receives the reflected infrared rays, resulting in the infrared ray generation mesh 20 rising in temperature and accumulating more thermal energy for increasing efficiency of generating infrared rays out of the infrared ray generation mesh 20.

In the current embodiment, the combustion device further comprises a bracket 50. As illustrated in FIG. 3, the bracket 50 includes an upper supporting plate 52, a middle supporting plate 54, a lower supporting plate 56 and an engaged member 58. The bracket 50 is for fixing the front cover 12, the rear cover 14 and the burners 30 to be at the relative position. The middle supporting plate 54 is fixed between the upper supporting plate 52 and the lower supporting plate 56. A fixed hole 59 is near the center of the upper supporting plate 52, wherein the engaged member 58 penetrates the fixed hole 59 to fix the rear cover 14 to the upper supporting plate 52, while the burners 30 are fixed to the lower supporting plate 56.

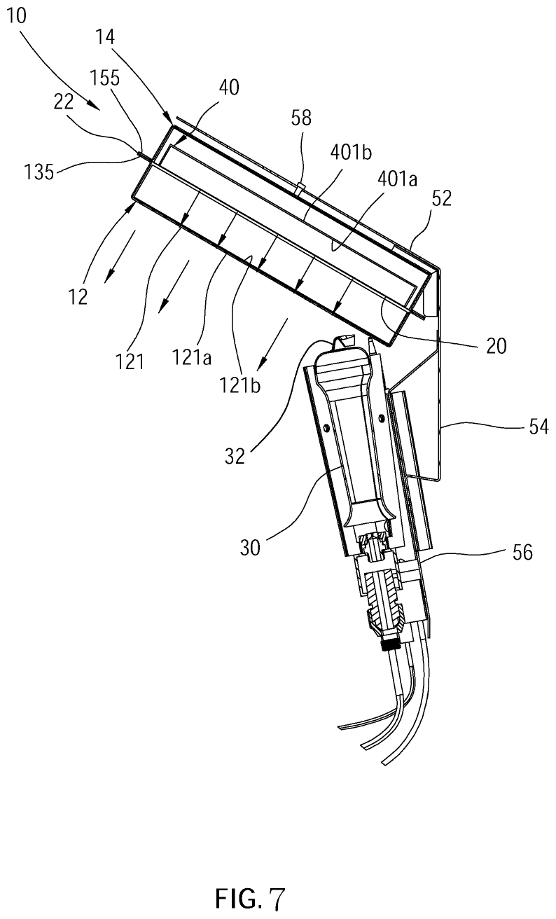

Therefore, as illustrated in FIG. 7, when the flames out of the flame outlets 32 of the burners 30 are applied to the infrared ray generation mesh 20, the infrared ray generation mesh 20 is heated to generate infrared rays, part of which passes the holes 124 of the front cover 12 to be emitted outwardly and another part of which is emitted toward the reflective surface 401a of the infrared reflective plate 40. With the reflective structure 42, the reflective surface 401a helps the reflected infrared rays to be uniformly scattered to the infrared ray generation mesh 20 which is heated again by the reflected infrared rays, resulting in the infrared ray generation mesh 20 accumulating more thermal energy generated by the infrared rays, rising in temperature, and generating more infrared rays to move along the direction of the front cover 12 and pass through the holes 124 of the front cover 12 for increasing the infrared intensity applied on an object by the combustion device 100. In practice, the reflective surface 401a need not include the reflective structure 42 but a flat surface; however, the reflective surface 401a is preferably provided with the reflective structure 42 to achieve the effect of reflecting infrared rays uniformly. Additionally, the front cover 12 is heated by flames out of the flame outlets 32 to generate infrared rays, and the flames pass through the holes 124 to form open fire.

It is noted that since the front cover 12 is flat, the scattering direction of infrared rays generated by the front cover 12 is essentially perpendicular to the flat cover plate 121, such that the infrared rays emitted by the combustion device 100 scatter along the same direction to apply uniformly to an object. The object receives more uniform infrared intensity per unit area.

In addition, the convex parts on the reflective surface 401a of the infrared reflective plate 40 have different densities, wherein a density of the convex parts on the surrounding wall 41 is greater than a density of the convex parts on the main board. In this way, the combustion device 100 further enhances the accumulation of the infrared rays in the vicinity of the surrounding wall 41 thanks to the greater density of the convex parts on the surrounding wall 41, thereby the infrared intensity generated by the infrared ray generation mesh 20 tends to be more uniform.

Furthermore, a density of the convex parts on the middle area of the main board 401 can be smaller than a density of the convex parts on the peripheral area of the main board 401, such that the efficiency to accumulate infrared rays is increased gradually from the middle area of the main board 401 to the peripheral area. Whereby, the area of the infrared ray generation mesh 20 corresponding to the peripheral area is heated more such that the infrared intensity generated by the infrared ray generation mesh 20 tends to be more uniform.

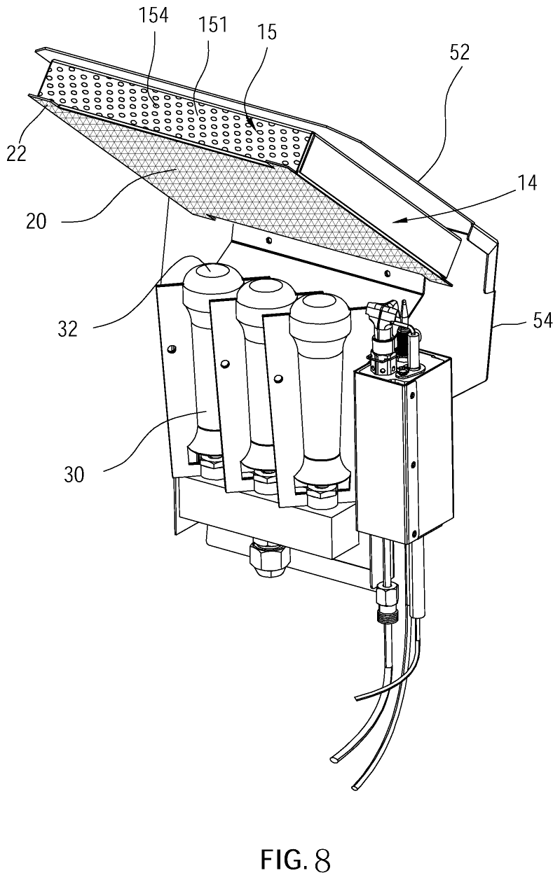

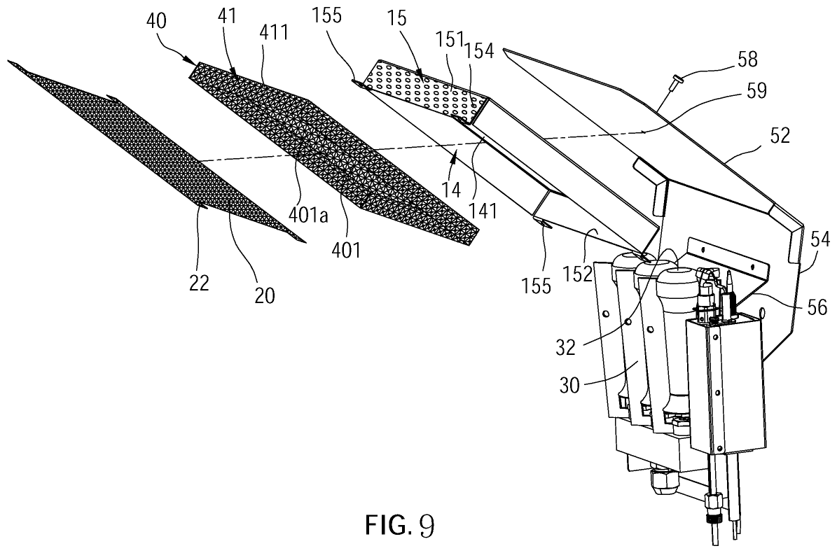

The second embodiment according to the present invention, as shown in FIGS. 8 and 9, includes a basic structure similar to that of the first embodiment; the difference between these two is in that, the structure of the second embodiment has no front cover 12 as shown in the first embodiment but expose the infrared ray generation mesh 20 thereof outside directly. Since no front cover 12 is disposed in the current embodiment, each flame outlet 32 of each of burners 30 is only applied to the infrared ray generation mesh 20, resulting in the infrared ray generation mesh 20 being heated to generate infrared rays. Part of the infrared rays are not blocked by the front cover 12 but scatter outwardly from the infrared ray generation mesh 20, while another part of the infrared rays are emitted toward the reflective surface 401a of the infrared reflective plate 40 which reflects the another part of the infrared rays back to the infrared ray generation mesh 20 to accumulate more thermal energy generated by the infrared rays on the infrared ray generation mesh 20. Whereby, the infrared ray generation mesh 20 rises in temperature to generate more infrared rays for increasing the infrared intensity applied to an object by the combustion device 100. With the design of no front cover 12, the cost of manufacturing the combustion device 100 can be reduced, and the performance of the infrared ray heat source of the combustion device 100 will not be affected.

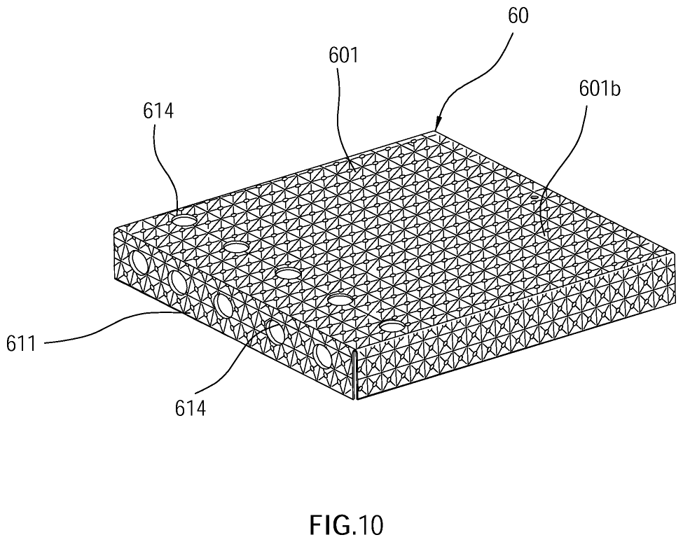

In addition, an infrared reflective plate 60 of a combustion device of the third embodiment according to the present invention is shown in FIG. 10. The infrared reflective plate 60 includes a basic structure similar to the infrared reflective plate 40 of the first embodiment; the difference between these two is in that, the upper side wall 611 of the infrared reflective plate 60 has a plurality of holes 614, while the vicinity of the top edge of the main board 601 has a plurality of holes 614 as well. When the flames generated by the flame outlet 32 flow along a reflective surface 601a of the infrared reflective plate 60 toward the top edge of the infrared reflective plate 60, the holes 614 help the flames that have flowed to the vicinity of the top edge of the infrared reflective plate 60 to pass through the holes 614 to form open fire, such that the gas flows more smoothly. With the holes 614, flames help the infrared ray generation mesh 20 and the front cover 12 to be heated more uniformly, resulting in more uniform infrared intensity emitted by the combustion device 100. It is noted that both the upper side wall 611 of the infrared reflective plate 60 and the vicinity of the top edge of the main board 601 may have a plurality of holes 614.

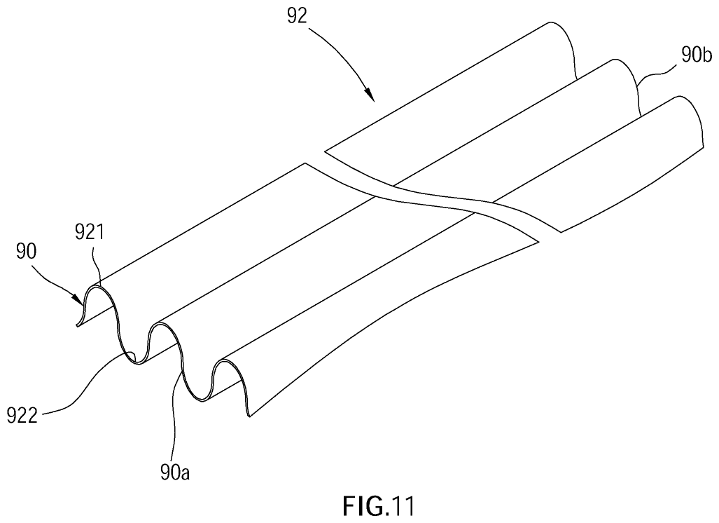

In addition, an infrared reflective plate 90 of the combustion device of the fourth embodiment according to the present invention is shown in FIG. 11. In practice, each of the convex parts 921 on the reflective structure 92 of the infrared reflective plate 90 is a strap in shape and forms a parallel arrangement with each other. A long axis of the convex parts 921 and a long axis of the embossings 922 extend along a predetermined direction from one end 90a of the infrared reflective plate 90 toward corresponding one end 90b.

With the above reflective structures of the infrared reflective plates, the flames are favorable to more uniformly heat the infrared ray generation mesh 20 and the front cover 12, keep the high temperature of the infrared ray generation mesh 20, and help the combustion device generate stronger and more uniform infrared rays.

In addition, when infrared rays scatter from the holes 124 of the front cover 12 and from the front cover 12 itself, the infrared rays are emitted outwardly along the same direction owing to the flat cover plate of the front cover, such that the intensity of heat per unit area an object heated by the infrared rays is more uniform.

It must be pointed out that the embodiments described above are only some embodiments of the present invention. All equivalent structures which employ the concepts disclosed in this specification and the appended claims should fall within the scope of the present invention.

What is claimed is:

1. A combustion device, comprising:
at least one burner having a flame outlet, wherein the at least one burner is for burning gas to generate flames through the flame outlet;
an infrared ray generation mesh which is corresponding to the flame outlet having a front side surface and a rear side surface positioned back-to-back; the infrared ray generation mesh being flame heated by the at least one burner to generate infrared rays; and
an infrared reflective plate disposed outside the rear side surface of the infrared ray generation mesh including a reflective surface facing the rear side surface, the reflective surface having a reflective structure which comprises a plurality of convex parts and a plurality of embossings, each of the embossings located between two adjacent convex parts.

2. The combustion device of claim 1, wherein the convex parts form a matrix arrangement.

3. The combustion device of claim 1, wherein the convex parts form a staggered arrangement.

4. The combustion device of claim 1, wherein each of the convex parts is conical.

5. The combustion device of claim 1, wherein the convex parts and the embossings extend in parallel along a predetermined direction.

6. The combustion device of claim 1, wherein the infrared reflective plate has at least one gap.

7. The combustion device of claim 1, wherein the infrared reflective plate has a plurality of holes.

8. An infrared reflective plate, including a reflective surface to reflect infrared rays, wherein the reflective surface has a reflective structure including a plurality of convex parts and a plurality of embossings, each of the embossings located between two adjacent convex parts.

9. The infrared reflective plate of claim 8, wherein the convex parts form a matrix arrangement.

10. The infrared reflective plate of claim 8, wherein the convex parts form a staggered arrangement.

11. The infrared reflective plate of claim 8, wherein each of the convex parts is conical.

12. The infrared reflective plate of claim 8, wherein the convex parts and the embossings extend in parallel along a predetermined direction.

13. The infrared reflective plate of claim 8, wherein the infrared reflective plate includes a main board and a surrounding wall connected to a peripheral edge of the main board, and a density of the convex parts on the surrounding wall is greater than a density of the convex parts on the main board.

14. The infrared reflective plate of claim 8, wherein the infrared reflective plate includes a main board which has a middle area and a peripheral area outside the middle area; a density of the convex parts on the middle area is smaller than a density of the convex parts on the peripheral area.
